(19) United States
(12) Patent Application Publication
(10) Pub. No.: US 2013/0194177 A1
(43) Pub. Date: Aug. 1, 2013

(54) PRESENTATION CONTROL DEVICE AND PRESENTATION CONTROL METHOD

(71) Applicant: Kotaro Sakata, Hyogo (JP)

(72) Inventor: Kotaro Sakata, Hyogo (JP)

(21) Appl. No.: 13/699,137

(22) PCT Filed: Jun. 14, 2012
(86) PCT No.: PCT/JP2012/003882

§ 371 Date: Nov. 20, 2012

(30) Foreign Application Priority Data
Jul. 29, 2011 (JP) 2011-167577

(51) Int. Cl. G06F 3/01

(52) U.S. Cl. CPC G06F 3/01
USPC 345/156

(57) ABSTRACT

A presentation control device casually presents information to the user based on how the user is watching a content item. In presenting the information to the user, the presentation control device: presents a sensory stimulus element having a first stimulation degree; changes a stimulation degree of the sensory stimulus element from the first stimulation degree, based on the magnitude of the reaction determined by the user reaction analyzing unit, and presents the sensory stimulus element; and, in the case where the magnitude of the reaction to the sensory stimulus element is smaller than a predetermined threshold, causes a sensory stimulus control unit to decrease the stimulation degree of the sensory stimulus element or stop presenting the sensory stimulus element. The reaction is observed within a predetermined time period which begins when the sensory stimulus element having the first stimulation degree is presented.

### TECHNICAL FIELD

The present invention relates to an information presentation device which presents information to a user.

### BACKGROUND ART

Larger and thinner displays and increasing collaboration between broadcasting and communications have allowed TVs to acquire multiple functions. In addition to simply used for viewing broadcast content items, those TVs are capable of providing multiple content items simultaneously and obtaining content-related information. One of proposed new functions of such a TV is to inform a user of various kinds of information related to daily life with appropriate timing.

The recent diffusion of networking functions of electric appliances makes it possible to connect a TV with a blue-ray recorder and an internet protocol (IP) camera, so that the user can operate multiple appliances with a single TV remote control and check a video of the IP camera on the TV screen. In addition to the electric appliances, the networking functions allow the TV to connect with home appliances, such as a washing machine, a refrigerator, and a microwave, so that the user can also check information on TV on each home appliance. In other words, a network is established between a display device, such as a TV, and other multiple appliances, and information is sent from each appliance to the display device. Through such a network, the user can obtain information on each appliance without getting closer to the appliance.

### CITATION LIST

### Patent Literature

[PTL 1]
Japanese Unexamined Patent Application Publication No. 2000-270236

### SUMMARY OF INVENTION

### Technical Problem

Suppose when the user is viewing a video, and information unrelated to the content video abruptly appears on the display. In the case where the user does not desire such information, this could bother the user viewing the video. Hence there should a technique for the display device and a system related to the display device to detect a state of the user and appropriately and casually present the user the information.

The present invention has an object to provide a presentation control device which casually present information to the user based on how the user is viewing a content item.

### Solution to Problem

In order to solve the above problem, a presentation control device according to an aspect of the present invention includes: a display unit which displays a video; a sensory stimulus control unit which presents a sensory stimulus element for notifying a user of information to be shown to the user through the display unit; a user status measuring unit which measures a status of the user; and a user reaction analyzing unit which determines a magnitude of a reaction of the user to the sensory stimulus element, based on an output from the user status measuring unit, wherein the sensory stimulus control unit: presents the sensory stimulus element having a first stimulation degree; changes a stimulation degree of the sensory stimulus element from the first stimulation degree, based on the magnitude of the reaction determined by the user reaction analyzing unit, and present the sensory stimulus element; and decreases the stimulation degree of the sensory stimulus element or stop presenting the sensory stimulus element in the case where the magnitude of the reaction of the user to the sensory stimulus element is smaller than a predetermined threshold, the reaction being observed within a predetermined time period which begins when the sensory stimulus element having the first stimulation degree is presented.

It is noted that the entire or the specific aspect of the present invention may be implemented in a form of a system, a method, an integrated circuit, a computer program, or a storage medium such as a computer readable a compact disc read only memory (CD-ROM), or may be implemented in a form of any given combination thereof.

### Advantageous Effects of Invention

The presentation control device and the presentation control method of the present invention can casually present information to the user based on how the user is viewing a content item.

### BRIEF DESCRIPTION OF DRAWINGS

FIG. 1 depicts a block diagram showing a functional structure of a presentation control device according to Embodiment 1 of the present invention.

FIG. 2 depicts a flowchart showing a flow of presentation control processing according to Embodiment 1 of the present invention.

FIG. 3A depicts a diagram showing a video capturing device which captures a video obtained in eye gaze direction detection processing according to Embodiment 1 of the present invention.

FIG. 3B depicts a diagram showing a video capturing device which captures a video obtained in the eye gaze direction detection processing according to Embodiment 1 of the present invention.

FIG. 3C depicts a diagram showing a video capturing device which captures a video obtained in the eye gaze direction detection processing according to Embodiment 1 of the present invention.

FIG. 4 depicts a flowchart showing a flow of the eye gaze direction detection processing according to Embodiment 1 of the present invention.

FIG. 5 depicts a diagram showing processing of a face orientation in the eye-gaze direction detection processing according to Embodiment 1 of the present invention.

FIG. 6 depicts a diagram showing calculation of a gaze direction reference plane according to Embodiment 1 of the present invention.

FIG. 7 depicts a diagram showing detection of the center of the black part of an eye according to Embodiment 1 of the present invention.

FIG. 8 depicts a diagram showing detection of the center of the black part of an eye according to Embodiment 1 of the present invention.

FIG. 9A exemplifies sensory stimulus elements according to Embodiment 1 of the present invention.

FIG. 9B exemplifies a sensory stimulus element displayed on a display unit according to Embodiment 1 of the present invention.

FIG. 9C exemplifies a sensory stimulus element shown on a bezel according to Embodiment 1 of the present invention.

FIG. 9D exemplifies a sensory stimulus element shown outside the display unit according to Embodiment 1 of the present invention.

FIG. 9E exemplifies a case where a video displayed on the display unit according to Embodiment 1 of the present invention is reduced, so that the video and the displayed sensory stimulus element do not overlap with each other.

FIG. 9F exemplifies a sensory stimulus element database according to Embodiment 1 of the present invention.

FIG. 9G exemplifies a variation on the sensory stimulus elements according to Embodiment 1 of the present invention.

FIG. 10 exemplifies how to present information according to Embodiment 1 of the present invention.

FIG. 11 exemplifies how to present information according to Embodiment 1 of the present invention.

FIG. 12 exemplifies how to present information according to Embodiment 1 of the present invention.

FIG. 13 shows a presentation control device according to Embodiment 2 of the present invention.

FIG. 14 shows another example of the presentation control device according to Embodiment 2 of the present invention.

### DESCRIPTION OF EMBODIMENTS

### [Insight as Basis of Invention]

As described in the Background Art, there are some proposed techniques to connect a display device with another home appliance via a network, and to obtain the information on the home appliance through the display device.

One of such techniques (See Patent Literature 1, for example) is on a display device which detects how a user grips a remote control using a grip sensor, and, based on the output from the grip sensor, switches between displaying and undisplaying the cursor and a graphical user interface (GUI). This is used to notify the user of information when the user grips the remote control without pressing a predetermined button.

Such a technique, however, cannot notify the user of the information in the case where the user keeps viewing a video without holding the remote control, since the display device switches screen displays based on the output from the grip sensor included in the remote control. Moreover, another problem to the technique is that, when the user grips the remote control for an operation, the information cannot be provided without bothering the user viewing the video regardless of the intension of the user.

In order to solve the above problems, a presentation control device according to an implementation of the present invention includes: a display unit which displays a video; a sensory stimulus control unit which presents a sensory stimulus element for notifying a user of information to be shown to the user through the display unit; a user status measuring unit which measures a status of the user; and a user reaction analyzing unit which determines a magnitude of a reaction of the user to the sensory stimulus element, based on an output from the user status measuring unit, wherein the sensory stimulus control unit: presents the sensory stimulus element having a first stimulation degree; changes a stimulation degree of the sensory stimulus element from the first stimulation degree, based on the magnitude of the reaction determined by the user reaction analyzing unit, and present the sensory stimulus element; and decreases the stimulation degree of the sensory stimulus element or stops presenting the sensory stimulus element in the case where the magnitude of the reaction of the user to the sensory stimulus element is smaller than a predetermined threshold, the reaction being observed within a predetermined time period which begins when the sensory stimulus element having the first stimulation degree is presented.

According to the structure, the display unit does not display information when the user is concentrating on the video on the display unit, and is showing a weak reaction to the sensory stimulus element. Hence such a feature makes it possible to provide an information control device having an information notifying capability which can prevent the abrupt appearance of information that the user does not desire, and operate based on how the user is viewing the content.

The sensory stimulus control unit may present the information to be shown to the user in the case where the magnitude of the reaction of the user to the sensory stimulus element is greater than or equal to a predetermined threshold, the reaction being observed within a predetermined time period which begins when the sensory stimulus element having the first stimulation degree is presented.

Here the information to be shown is displayed on the display unit when the user is not concentrating on the video on the display unit and is showing a strong reaction to the sensory stimulus element.

The sensory stimulus control unit may present a visual stimulus element as the sensory stimulus element, and calculate the stimulation degree of the sensory stimulus element based on a level of attractiveness to the visual stimulus element.

The sensory stimulus control unit may present an auditory stimulus element as the sensory stimulus element, and calculate the stimulation degree of the sensory stimulus element based on at least one of volume of the auditory stimulus element and a musical pitch of the auditory stimulus element.

The sensory stimulus control unit may present a tactile stimulus element as the sensory stimulus element, and calculate the stimulation degree of the sensory stimulus element based on at least one of feeling of pressure of the tactile stimulus element and feeling of touch of the tactile stimulus element.

The sensory stimulus control unit may present an olfactory stimulus element as the sensory stimulus element, and calculate the stimulation degree of the sensory stimulus element based on at least one of how strong or weak odor of the olfactory stimulus element is and how good or bad the odor of the olfactory stimulus element is.

The sensory stimulus control unit may further include a sensory stimulus element database which stores the sensory stimulus element having multiple stimulation degrees including the stimulation degree, and may present the sensory stimulus element with reference to data stored in the sensory stimulus element data base.

The sensory stimulus control unit may present the sensory stimulus element on a screen of the display unit.

The sensory stimulus control unit may cause a presenting device, provided to a bezel of the display unit, to present the sensory stimulus element.

Furthermore, the sensory stimulus control unit may present the sensory stimulus element outside the display unit.

The sensory stimulus control unit may present the sensory stimulus element by superimposing the sensory stimulus element on the video displayed by the display unit. The sensory stimulus control unit may present the sensory stimulus element which corresponds to brightness or a color contrast of the video displayed by the display unit. The sensory stimulus control unit may reduce the video displayed by the display unit, and present the sensory stimulus element in a manner that the video and the sensory stimulus element do not overlap with each other.

The sensory stimulus control unit may present the auditory stimulus element having audio properties which correspond to audio of the video displayed by the display unit.

The sensory stimulus control unit may present the sensory stimulus element having the stimulation degree which is set based on importance of the information to be shown to the user.

The user status measuring unit may further include an eye gaze measuring unit which measures an eye gaze movement of the user as the status of the user. The user reaction analyzing unit may determine the magnitude of the reaction of the user to the sensory stimulus element, based on an eye gaze retention time which is (i) measured by the eye gaze measuring unit as the eye gaze movement of the user and (ii) given to the sensory stimulus element. The user reaction analyzing unit may determine the magnitude of the reaction of the user to the sensory stimulus element, based on the number of saccades which are (i) measured by the eye gaze measuring unit as the eye gaze movement of the user and (ii) observed between the sensory stimulus element and a main area of the video displayed by the display unit. The user reaction analyzing unit may determine the magnitude of the reaction of the user to the sensory stimulus element, based on eye blink frequency which is measured by the eye gaze measuring unit as the eye gaze movement of the user.

The user status measuring unit may further include a facial expression measuring unit which measures a facial expression of the user as the status of the user. The user reaction analyzing unit may determine the magnitude of the reaction of the user to the sensory stimulus element, based on a change of the facial expression of the user measured by the facial expression measuring unit. The user status measuring unit may further include a posture measuring unit which measures a posture of the user as the status of the user. The user reaction analyzing unit may determine the magnitude of the reaction of the user to the sensory stimulus element, based on a change of the posture of the user measured by the posture measuring unit.

The display unit may simultaneously display a first video and a second video which is smaller than the first video in size on a screen of the display unit. The second video may be the information to be shown to the user as well as is the sensory stimulus element to be presented by the sensory stimulus control unit. The user reaction analyzing unit may determine a magnitude of a reaction of the user to the second video, based on an output from the user status measuring unit. The sensory stimulus control unit may: present the second video having a first stimulation degree; change a stimulation degree of the second video from the first stimulation degree, based on the magnitude of the reaction determined by the user reaction analyzing unit, and present the second video; decrease the stimulation degree of the second video in the case where a magnitude of a reaction of the user to the second video is smaller than a predetermined threshold, the reaction being observed within a predetermined time period which begins when the second video having the first stimulation degree is presented; and present the second video on the display unit in the case where the magnitude of the reaction of the user to the second video is greater than or equal to the predetermined threshold, the second video being larger than the first video in size on the screen of the display unit.

In other words, when the display device simultaneously shows multiple videos, one of these videos may be used as the sensory stimulus element.

The sensory stimulus control unit may change the stimulation degree of the second video by changing an appearance of the second video.

The sensory stimulus control unit may change the stimulation degree of the second video by changing a feature of the second video.

The sensory stimulus control unit may present a still picture as the second video, and change the stimulation degree of the second video by changing the presented still picture to another still picture which differs from the presented still picture.

As described above, the sensory stimulus control unit can change the stimulation degree by changing the appearance and the feature of a video provided as a sensory stimulus element.

An integrated circuit according to an implementation of the present invention performs presentation control. The integrate circuit includes: a sensory stimulus control which presents a sensory stimulus element for notifying a user of information to be shown to the user; a user status measuring unit which measures a status of the user; and a user reaction analyzing unit which determines a magnitude of a reaction of the user to the sensory stimulus element, based on an output from the user status measuring unit, wherein the sensory stimulus control unit: presents the sensory stimulus element having a first stimulation degree; changes a stimulation degree of the sensory stimulus element from the first stimulation degree, based on the magnitude of the reaction determined by the user reaction analyzing unit, and present the sensory stimulus element; and decreases the stimulation degree of the sensory stimulus element or stops presenting the sensory stimulus element in the case where the magnitude of the reaction of the user to the sensory stimulus element is smaller than a predetermined threshold, the reaction being observed within a predetermined time period which begins when the sensory stimulus element having the first stimulation degree is presented.

Such a structure achieves an effect similar to that of the presentation control device.

A presentation control method according to an implementation of the present invention includes: presenting a sensory stimulus element for notifying a user of information to be shown to the user through a display unit; measuring a status of the user; and determining a magnitude of a reaction of the user to the sensory stimulus element, based on an output in the measuring, wherein the presenting involves: presenting the sensory stimulus element having a first stimulation degree; changing a stimulation degree of the sensory stimulus element from the first stimulation degree, based on the magnitude of the reaction determined in the determining, and presenting the sensory stimulus element; and decreasing the stimulation degree of the sensory stimulus element or stop presenting the sensory stimulus element in the case where the magnitude of the reaction of the user to the sensory stimulus element is smaller than a predetermined threshold, the reaction being observed within a predetermined time period which begins when the sensory stimulus element having the first stimulation degree is presented.

Such a feature achieves an effect similar to that of the presentation control device.

It is noted that the present invention can also be implemented as a program causing a computer to execute the respective steps included in the presentation control method. As a matter of course, such a program may be distributed via a non-transitory recording medium such as a compact disc read only memory (CD-ROM), and a transmission medium such as the Internet.

Hereinafter, embodiments of the present invention are described with reference to the drawings.

It is noted that the embodiments below are specific examples of the present invention. The numerical values, shapes, materials, constitutional elements, arrangement positions and connecting schemes of the constitutional elements, steps, and an order of steps all described in the embodiments are examples, and shall not be defined as they are. Hence, among the constitutional elements in the embodiment, those not described in an independent claim representing the most generic concept of the present invention are described as given constitutional elements.

### Embodiment 1

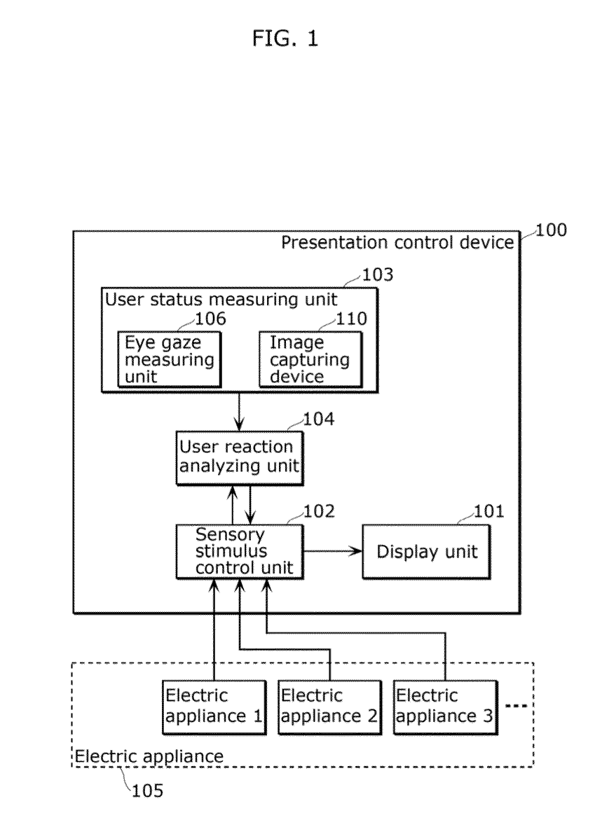

FIG. 1 depicts a block diagram showing a functional structure of a presentation control device according to Embodiment 1 of the present invention.

As shown in FIG. 1, a presentation control device 100 includes: a display unit 101 which displays a video; a sensory stimulus control unit 102 which presents the user, via the display unit 101, that information to be shown is found; a user status measuring unit 103 which measures a status of the user; and a user reaction analyzing unit 104 which determines a magnitude of a reaction of the user to the sensory stimulus element, based on an output from the user status measuring unit 103.

Furthermore, the presentation control device 100 is connected to one or more electric appliances 105. The electric appliance 105 includes, for example, an air conditioner, a refrigerator, a microwave oven, and a BD recorder. The presentation control device 100 and the electric appliance 105 are connected with each other via a wired network including a local area network (LAN) and a universal serial bus (USB) cable and via a wireless LAN and Wi-Fi®.

Through the networks, the presentation control device 100 obtains, from each of the electric appliances 105, information such as an operation status and a communication status of each appliance. The above information includes data of a viewing content item which the presentation control device 100 directly receives using an antenna.

The display unit 101 is, for example, a liquid crystal display (LCD) and used for displaying a video. Instead of the LCD, the display unit 101 may be the plasma display panel (PDP) and the organic light emitting display (OLED). Moreover, the display unit 101 may be a projector to project a video on a surface such as a wall.

When information to be shown to the user is found, the sensory stimulus control unit 102 presents the user a sensory stimulus element which stimulates a sense of the user. The sensory stimulus element includes a visual stimulus element, an auditory stimulus element, a tactile stimulus element, and an olfactory stimulus element. The visual stimulus element is used in Embodiment 1.

The user status measuring unit 103 includes at least one image capturing device (camera) 110. The user status measuring unit 103 also includes an eye gaze measuring unit 106 which measures an eye gaze of the user. It is noted that the user status measuring unit 103 may include at least one of the flowing: the eye gaze measuring unit 106 which measures the eye gaze of the user; a facial expression measuring unit which measures the facial expression of the user; and a posture measuring unit which measures the posture of the user. The eye gaze, the facial expression, and the posture of the user are beneficial information for detecting the magnitude of the reaction of the user to the sensory stimulus element.

For example, the eye gaze measuring unit 106 detects the eye gaze direction of the user; that is, the direction that the user is looking at. Then, based on the detected eye gaze direction, the eye gaze measuring unit 106 measures a gaze coordinate system indicating, on the screen, a movement locus of a position at which the user is gazing. Specifically, based on the eye gaze direction and the position of the user, the eye gaze measuring unit 106 measures, as a gaze position, a point at the intersection of the screen and the straight line extending from the user in the gaze direction. Then the eye gaze measuring unit 106 measures, as the gaze coordinate system, chronological coordinates indicating the calculated gaze position.

The user reaction analyzing unit 104 determines the magnitude of the reaction of the user to the sensory stimulus element, based on the output from the user status measuring unit 103. For example, based on the gaze coordinate system measured by the eye gaze measuring unit 106, the user reaction analyzing unit 104 measures an eye gaze retention time given to the position where the sensory stimulus element is presented. The user reaction analyzing unit 104 determines that the magnitude of the reaction of the user to the sensory stimulus element is greater as the eye gaze retention time is longer. Moreover, the magnitude of the reaction of the user may be determined based on the number of saccades observed between the main area of the video displayed by the display unit 101 and the position where the sensory stimulus element is presented. Specifically, the user produces a greater magnitude of the reaction to the sensory stimulus element as more saccades are observed at the position where sensory stimulus element is presented. Furthermore, the magnitude of the reaction to the user may be determined based on eye blink frequency measured by the eye gaze measuring unit. Specifically, the magnitude of the reaction to the user is greater as the eye blink frequency increases.

Described next are various operations of the presentation control device 100.

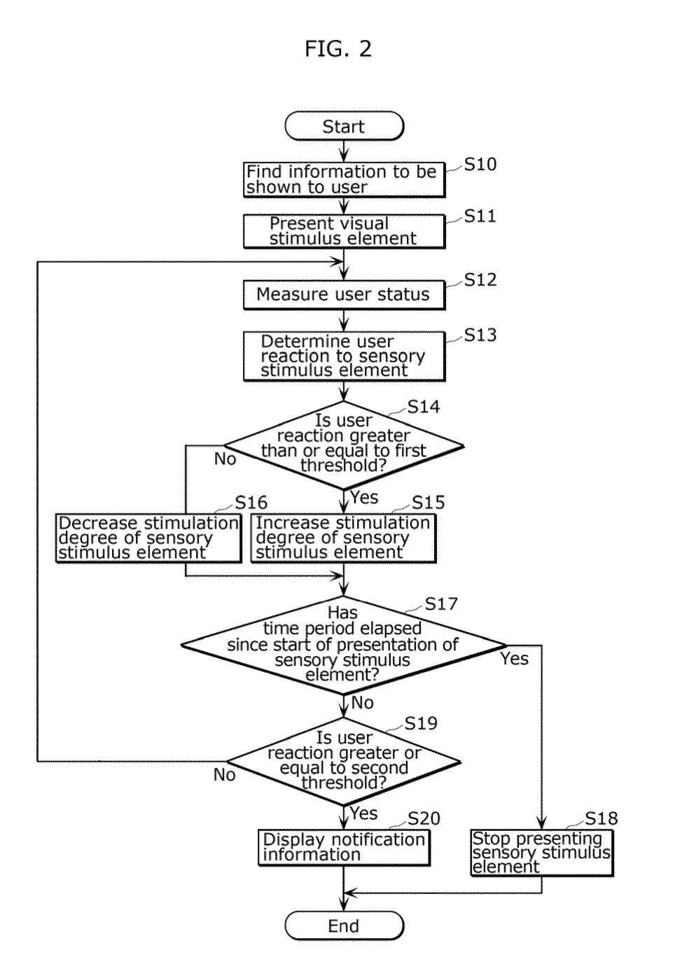

FIG. 2 depicts a flowchart showing a flow of presentation control processing according to Embodiment 1 of the present invention.

When the presentation control device 100 receives data from the electric appliance 105 and information to be shown to the user is found (S10), the sensory stimulus control unit 102 presents a visual stimulus element (S11). The user status measuring unit 103 measures a status of the user (S12). Based on the result of the measurement by the user status measuring unit 103, the user reaction analyzing unit 104 determines a magnitude of a reaction of the user to the sensory stimulus element (S13). The magnitude of the reaction of the user to the sensory stimulus element is taken as the attention degree of the user to the sensory stimulus element. In the case where the magnitude of reaction of the user to the sensory stimulus element is greater than or equal to a first threshold (S14: Yes), the sensory stimulus control unit 102 increases the stimulation degree of the sensory stimulus element (S15). In the case where the magnitude of the reaction of the user to the sensory stimulus element is smaller than the first threshold (S14: No), the sensory stimulus control unit 102 decreases the stimulation degree of the sensory stimulus element (S16). Then, in the case where a predetermined time period has elapsed since the start of the presentation of the sensory stimulus element (S17: Yes), the sensory stimulus control unit 102 stops presenting the sensory stimulus element (S18). In the case where the predetermined time period has not elapsed since the start of the presentation of the sensory stimulus element (S17: No), the sensory stimulus control unit 102 determines whether or not the magnitude of the reaction of the user to the sensory stimulus element is greater than or equal to a second threshold (S19). In the case where the magnitude of the reaction of the user to the sensory stimulus element is greater than or equal to the second threshold (S19: Yes), the sensory stimulus control unit 102 displays notification information (S20).

It is noted that the processing of Step S11, and the processing of Step S12 and S13 may be simultaneously executed. The processing of Step S11 and the processing of Step S12 may be executed in reverse.

As described above, the presentation control device 100 controls the presentation of a sensory stimulus element for notifying the user of information to be shown to the user. Consequently, the presentation control device 100 can casually inform the user of the information to be shown to the user, based on how the user is viewing the content item.

Detailed below are schemes included in the above presentation control processing.

### <Measuring User Status>

Detailed first is how to measure a user status.

The user status measuring unit 103 includes: the eye gaze measuring unit 106 which measures, as the user status, the eye gaze of the user; and a video capturing device 110. Detailed below is how the eye gaze measuring unit 106 detects an eye gaze direction.

In Embodiment 1, the eye gaze direction is calculated based on the combination of the orientation of the user's face (hereinafter, referred to as face orientation) and the direction of the black part of the eye to the face orientation of the user (hereinafter, referred to as black-part-of-the eye direction). Next the eye gaze measuring unit 106 first estimates the three-dimensional face orientation of the user. Then the eye gaze measuring unit 106 estimates the black-part-of-the-eye direction. Finally the eye gaze measuring unit 106 calculates the eye gaze direction, combining the face orientation and the black-part-of-the-eye direction.

It is noted that the eye gaze measuring unit 106 does not necessarily have to calculate the eye gaze direction based on the combination of the face orientation and the black-part-of-the-eye direction. For example, the eye gaze measuring unit 106 may calculate the eye gaze direction based on the center of the eyeball and the center of the iris (black part of the eye). In other words, the eye gaze measuring unit 106 may calculate, as the eye gaze direction, a three-dimension vector between a three-dimensional position of the center of the eyeball and a three-dimensional position of the center of the iris (black part of the eye).

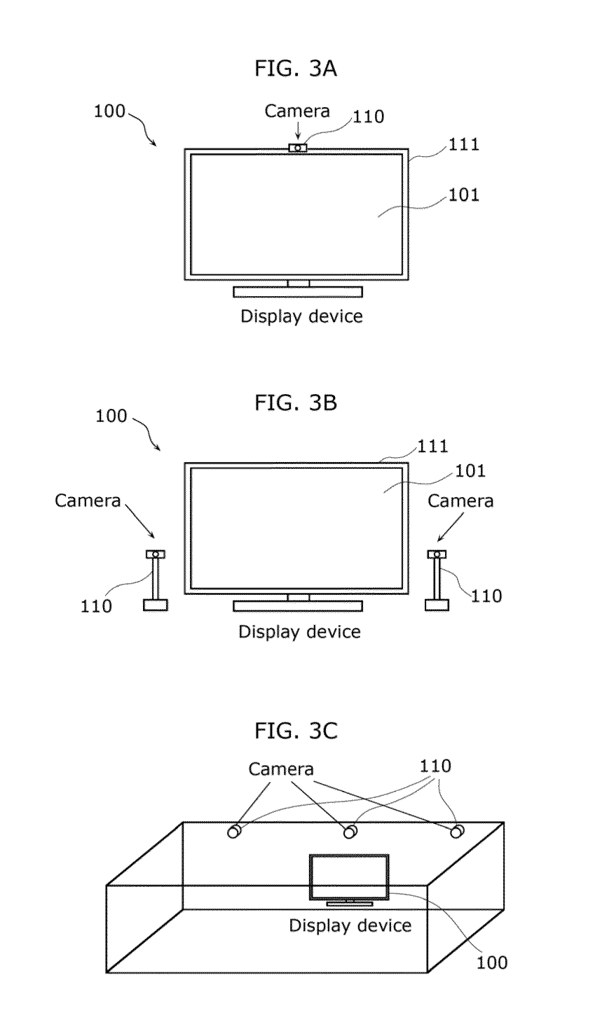

FIGS. 3A to 3C exemplifies how to place a video capturing device which captures a video obtained in eye-gaze direction detection processing according to Embodiment of the present invention. The image capturing device 110 is provided to capture a video of the user in front of the display unit 101 of the presentation control device 100. For example, the image capturing device 110 is provided on a bezel 111 of the presentation control device 100 as shown in FIG. 3A. Furthermore, the image capturing device 110 may be separately provided from the presentation control device 100 as shown in FIG. 3C.

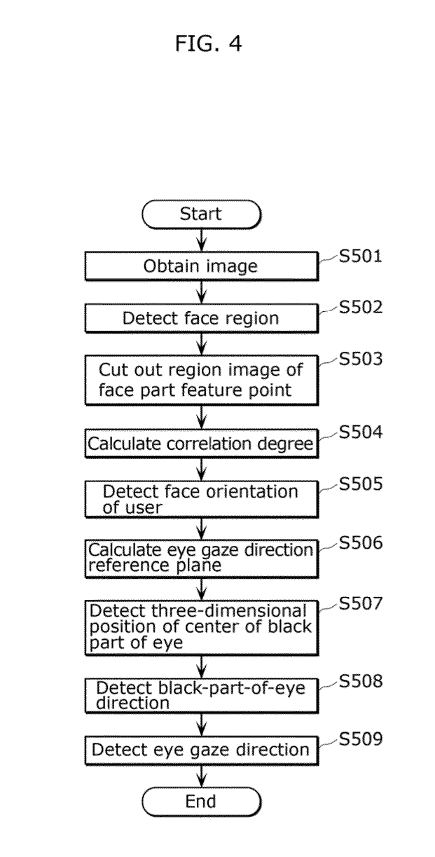

FIG. 4 depicts a flowchart showing a flow of the eye gaze direction detection processing according to Embodiment 1 of the present invention.

First, the eye gaze measuring unit 106 obtains a video, captured by the image capturing device 110, of the user who is in front of the screen (S501). Then the eye gaze measuring unit 106 detects a face region out of the obtained image (S502). Next the eye gaze measuring unit 106 applies, to the detected face region, regions each having a face part feature point, and cuts out a region image of each face part feature point (S503). Here, the face part feature point is associated with each reference face orientation.

The eye gaze measuring unit 106 then calculates correlation degrees between the cut-out region images and pre-stored template Images (S504). Then, based on the ratio of the calculated correlation degrees, the eye gaze measuring unit 106 calculates a weighted sum by weighting and adding angles of the corresponding reference face orientations. Finally, the eye gaze measuring unit 106 detects the weighted sum as the user's face orientation corresponding to the detected face region (S505).

Next the eye gaze measuring unit 106 detects three-dimensional positions of inner corners of both eyes of the user using the image captured by the image capturing device 110, and calculates an eye gaze direction reference plane using the detected three-dimensional positions of the inner corners of the both eyes (S506). After that, the eye gaze measuring unit 106 detects the three-dimensional positions of the centers of the black parts of the both eyes of the user, using the image captured by the image capturing device 110 (S507). The eye gaze measuring unit 106 then detects the black-part-of-the-eye direction, using the three-dimensional positions of the centers of the black parts of the both eyes and the eye gaze direction reference plane (S508).

Then the eye gaze measuring unit 106 detects the eye gaze direction of the user, using the detected user's face orientation and the black-part-of-the-eye direction (S509).

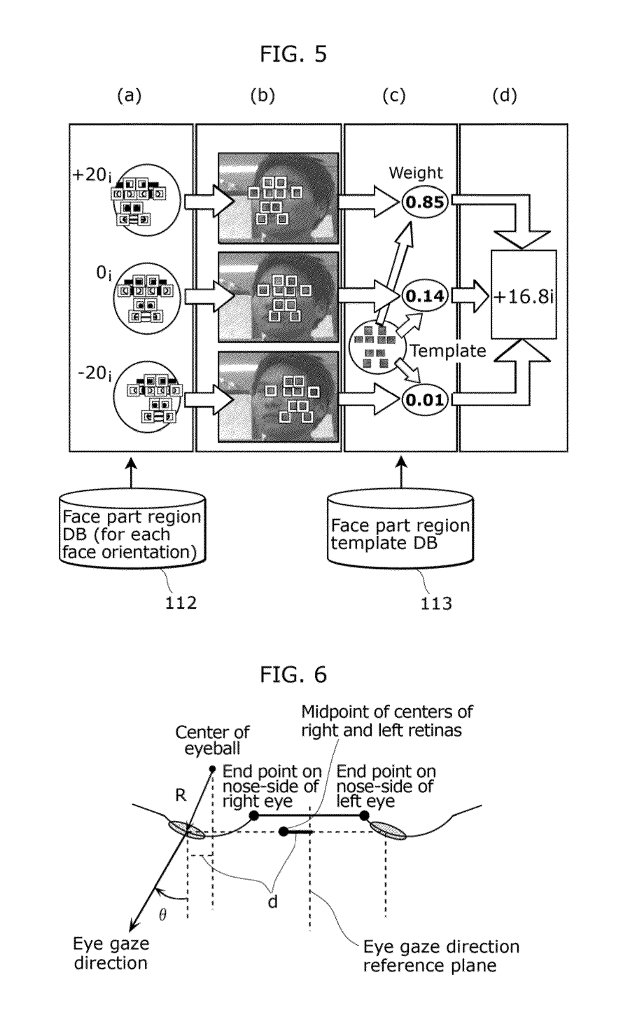

FIG. 5 shows in detail processing of the face orientation detection processing for S501 through S505 in FIG. 4.

The eye gaze measuring unit 106 includes a face part region database (DB) 112 and a face part region template database (DB) 113. Both of the DBs 112 and 113 store regions of face part feature points for each reference face orientation. As shown in the illustration (a) in FIG. 5, the eye gaze measuring unit 106 reads out, from the face part region DB 112, regions each having a face part feature point. As shown in the illustration (b) in FIG. 5, the eye gaze measuring unit 106 then (i) applies the regions having the face part feature points to a face region of a captured image for each reference face orientation, and (ii) cuts out a region image having the face part feature points for each reference face orientation.

Then, as shown in the illustration (c) in FIG. 5, the eye gaze measuring unit 106 calculates, for each reference face orientation, a correlation degree between the cut out region image and a template image stored in the face part region template DB 113. The eye gaze measuring unit 106 also calculates a weight for each reference face orientation according to the magnitude of the calculated correlation degree. For example, the eye gaze measuring unit 106 calculates, as the weight, the ratio of the correlation degree of each reference face orientation to the total sum of the degrees of correlation of the reference face orientations.

After that, as shown in the illustration (d) in FIG. 5, the eye gaze measuring unit 106 calculates the total sum of the values each of which is obtained by multiplying the angle of the reference face orientation by the calculated weight, and detects the calculation result as the face orientation of the user.

In the example of the illustration (d) of FIG. 5, weighting and detection of the face orientation are as follows: the angle of a reference face orientation plus 20 degrees is weighted “0.85”; the angle of facing front is weighted “0.14”; and the angle of a reference face orientation minus 20 degrees is weighted “0.01”. Thus, the eye gaze measuring unit 106 detects the face orientation to be 16.8 degrees (=20×0.85+0×0.14+(−20)×0.01).

In Embodiment 1, the eye gaze measuring unit 106 employs a region image having a face part feature point to calculate a correlation degree; instead, the eye gaze measuring unit 106 may calculate a correlation degree employing a video having the entire face region.

Other exemplary techniques for detecting a face orientation are to detect face part feature points, such as an eye, a nose, or a mouth, from a face image, and to calculate the face orientation based on the positional relation of the face part feature points.

One of such techniques to calculate a face orientation based on the positional relation of the face part feature points is to rotate, enlarge, and reduce a previously-prepared three-dimensional model of a face part feature point so that the three-dimensional model most matches a face part feature point obtained from one camera, and calculate the face orientation from the obtained rotation amount of the three-dimensional model.

Another technique to calculate a face orientation based on the positional relation of the face part feature points is to (i) calculate a three-dimensional position for each face part feature point out of a mismatch found on the images of positions of face part feature points in the right and left cameras, using the principle of stereo disparity based on images captured by two cameras to, and (ii) obtain the face orientation based on the positional relation of the obtained face part feature points. Specifically, the technique involves detecting, as the face orientation, a direction of a normal line on a plane including three-dimensional coordinate points of a mouth and both eyes. Such a technique may be employed for the eye gaze direction detection processing of the presentation control device 100.

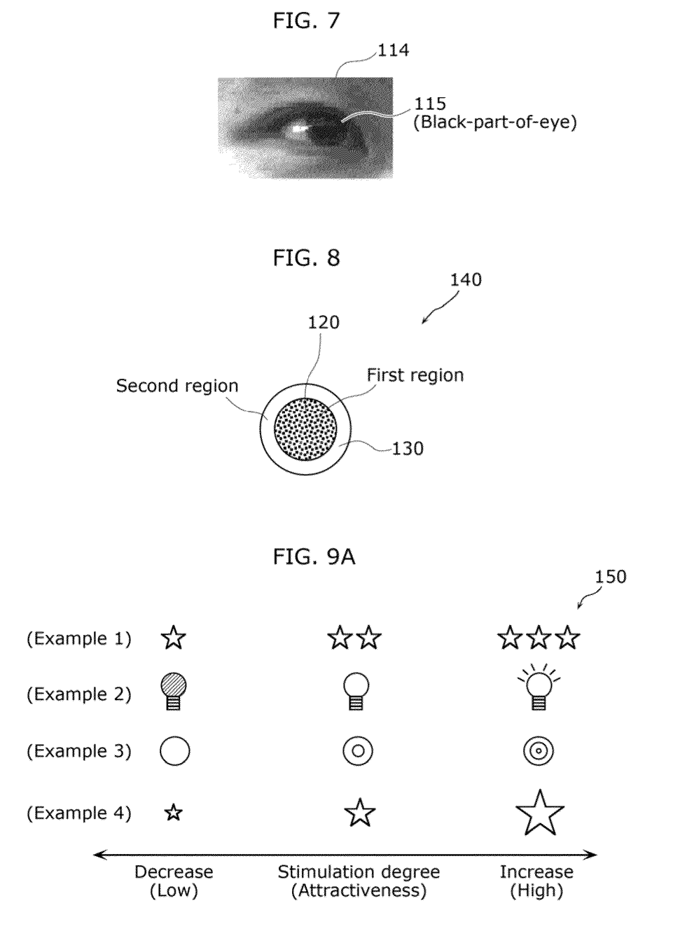

Detailed next is how to detect the black-part-of-the-eye direction in S506 through S508 with reference to FIGS. 6 to 8.

In Embodiment 1, the eye gaze measuring unit 106 first calculates an eye gaze direction reference plane, then detects the three-dimensional position of the center of the black part of the eye, and finally detects the black-part-of-the-eye direction.

Described first is how to calculate the eye gaze direction reference plane.

FIG. 6 depicts a diagram showing calculation of a gaze direction reference plane according to Embodiment 1 of the present invention.

The eye gaze direction reference plane is used as a reference in detecting the black-part-of-the eye direction, and is a bilateral symmetry plane of a face as shown in FIG. 6. The positions of the inner corners of the eyes show fewer facial movements than other face parts such as the tails of the eyes, corners of a mouth, or eyebrows, and thus cause less false detection. Thus the eye gaze measuring unit 106 calculates the eye gaze direction reference plane that is the bilateral symmetric plane of the face, using the three-dimensional positions of the inner corners of the eyes.

More particularly, the eye gaze measuring unit 106 detects the inner corner regions of both eyes for each of two images (stereo images) captured by a stereo camera, that is a kind of the image capturing device 110, using a face detection module and a face part detection module included in the eye gaze measuring unit 106. The eye gaze measuring unit 106 then measures the three-dimensional positions of the inner corners of the both eyes, based on a mismatch (disparity) between the images of the detected inner corner regions. Furthermore, as shown in FIG. 6, the eye gaze measuring unit 106 calculates, as the eye gaze direction reference plane, the perpendicular bisecting plane dividing a segment whose endpoints start at the three-dimensional positions of the inner corners of the both eyes.

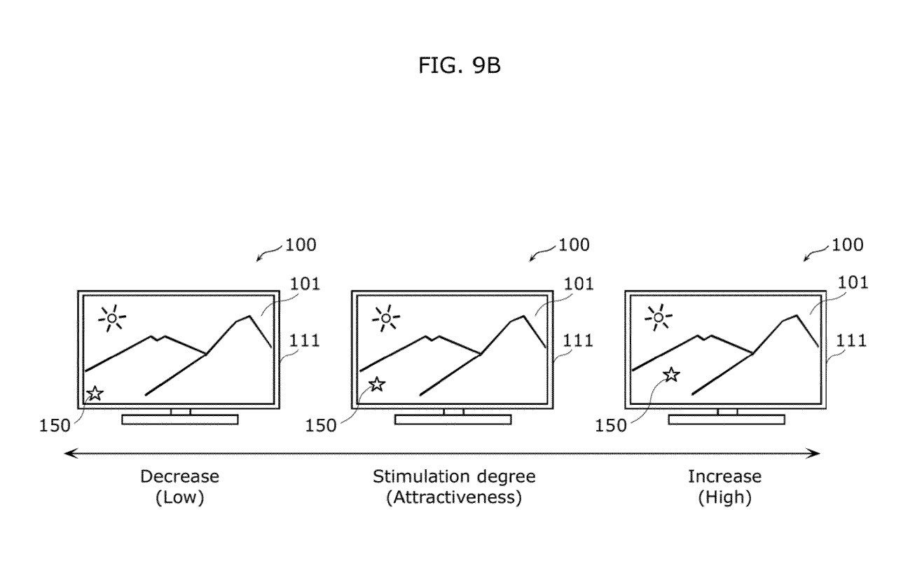

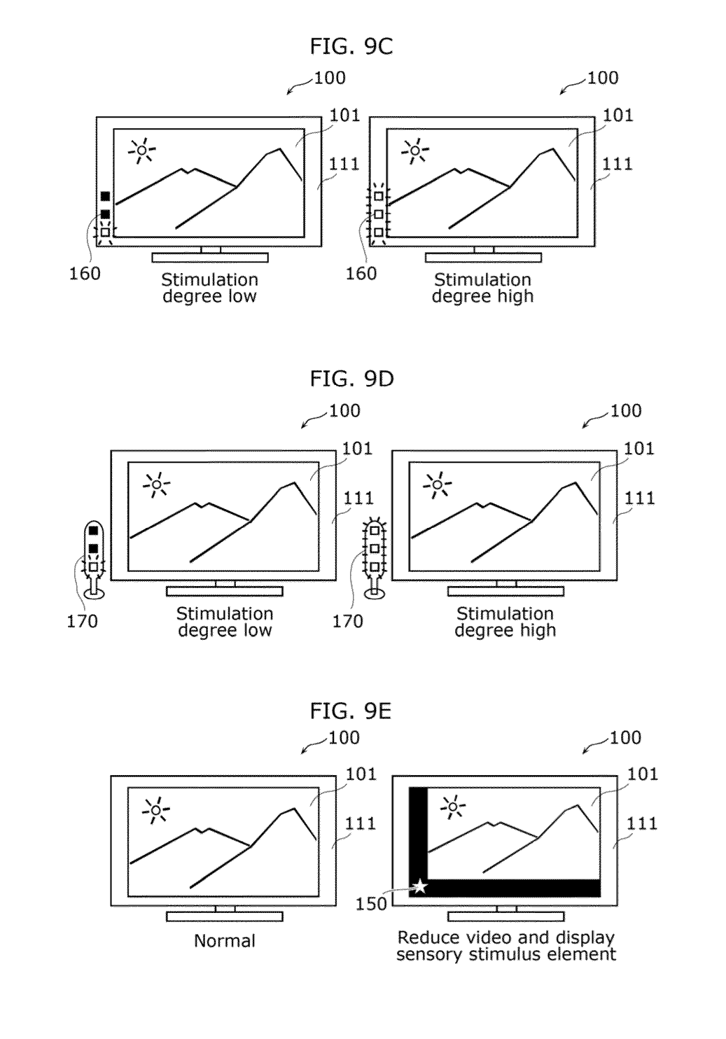

Described next is how to detect the center of the black part of the eye. FIGS. 7 and 8 depict diagrams showing the detection of the center of the black part of the eye according to Embodiment 1 of the present invention.

People visually recognize an object when light from the object arrives at the retina via the pupil and is converted into an electric signal, and then the electric signal is transmitted to the brain. Thus the eye gaze direction can be detected based on the position of the pupil. However, the iris of Japanese people's eye is black or blown. Thus, it is difficult to distinguish between a pupil and an iris through image processing. The center of the pupil approximately matches with the center of the black part of an eye (including both of the pupil and the iris). Hence, in Embodiment 1, the eye gaze measuring unit 106 detects the center of the black part of the eye when detecting the direction of the black part of the eye.

First the eye gaze measuring unit 106 detects the positions of the corner and the tail of an eye from a captured image. Then, as a black-part-of-eye region, the eye gaze measuring unit 106 detects a region 115 with little luminance from an area including the corner and the tail of the eye as shown in FIG. 7. Specifically, for example, the eye gaze measuring unit 106 detects, as the black-part-of-the-eye region, a region whose (i) luminance is equal to or smaller than a predetermined threshold and (ii) size is greater than a predetermined size.

Next the eye gaze measuring unit 106 sets a black-part-of-the-eye detecting filter 140 to any given position in the black-part-of-the eye region. Here the black-part-of-the-eye detecting filter 140 includes a first region 120 and a second region 130 as shown in FIG. 8. Then the eye gaze measuring unit 106 searches for a position, of the black-part-of-the-eye detecting filter 140, at which an inter-regional dispersion between (i) the luminance of a pixel in the first region 120 and (ii) the luminance of a pixel in the second region 130 is the greatest. The eye gaze measuring unit 106 then detects the position indicated in the search result as the center of the black-part-of-the-eye. Similar to the above, the eye gaze measuring unit 106 finally detects the three-dimensional position of the center of the black-part-of-the-eye, based on the mismatch of the centers of the black-part-of-the-eyes in the stereo image.

Furthermore, described is how to detect the black-part-of-the-eye direction.

The eye gaze measuring unit 106 detects a black-part-of-the-eye direction based on the calculated eye gaze direction reference plane and the detected three-dimensional position of the center of the black-part-of-the-eye. Adult eyeballs rarely vary in diameter from person to person. In the case of Japanese people, for example, the diameter is approximately 24 mm. Once position of the center of the black part of the eye is found when a user looks into a reference direction (front, for example), the eye gaze measuring unit 106 obtains displacement from the center positions to current center positions of the black part of the eyes. Then the eye gaze measuring unit 106 calculates to convert the obtained displacement into the black-part-of-the-eye direction.

When the user faces the front, the midpoint of the centers of the black parts of the both eyes is in the middle of the face, that is, on the gaze direction reference plane. Taking advantage of this phenomenon, the eye gaze measuring unit 106 calculates the distance between the midpoint of the centers of the black parts of the both eyes and the gaze direction reference plane to detect the black-part-of-the-eye direction.

Specifically, using the eyeball radius “R” and the distance “d” between the midpoint of the segment lying across the centers of the black parts of the both eyes and the gaze direction reference plane, the eye gaze measuring unit 106 detects, as the black-part-of-the-eye direction, a rotational angle θ in a horizontal direction with respect to a face orientation as shown in Expression 1.

$$\begin{matrix}[ Math . 1 ] & \\ θ = {sin}^{- 1} ( \frac{d}{R} ) & Expression 1\end{matrix}$$

As described above, the eye gaze measuring unit 106 detects the black-part-of-the-eye direction, based on the eye gaze direction reference plane and three-dimensional positions of the centers of the black parts of both of the eyes. Then, based on the detected user's face orientation and black-part-of-the-eye direction, the eye gaze measuring unit 106 detects the gaze direction of the user in a real space.

Various kinds of techniques are available for detecting the eye gaze direction, including the corneal reflex technique, the electrooculography (EGO) technique, the search coil technique, and the scleral reflex technique. Thus, the eye gaze measuring unit 106 does not necessarily use the above described technique to detect the eye gaze direction. For example, the eye gaze measuring unit 106 may detect the gaze direction based on the corneal reflex technique.

The corneal reflex technique is to measure an eye movement based on a position of a corneal reflex image (purkinje image) that appears brightly when point light illumination is irradiated on a cornea. The center of eyeball rotation and the center of convex of a cornea do not match. Thus, when the cornea is used as a convex mirror and reflection points of a light source are collected by a convex lens or the like, the collected point moves along the rotation of the eyeball. The points are captured by the image capturing device 110, and the eye movement is measured.

In Embodiment 1, the user status measuring unit 103 includes the eye gaze measuring unit 106. The user status measuring unit 103 may further include a facial expression measuring unit which measures a facial expression of the user as the status of the user. The user reaction analyzing unit 104 may determine the magnitude of the reaction of the user to a sensory stimulus element, based on the change of the facial expression of the user measured by the facial expression measuring unit. There are a wide variety of techniques for facial expression recognition. Such techniques involves extracting a dynamic feature amount based on an optical flow and applying a pattern recognition technique such as the template matching and the principal component analysis (PCA), the discriminatory analysis, and the support vector machine (SVM). There are also many proposed techniques to utilize temporal pattern recognition techniques including the hidden Markov model (HMM). The facial expression measuring unit uses such techniques, accordingly, and measures the facial expression.

The user status measuring unit 103 may further include a posture measuring unit which measures the posture of the user as a status of the user. The user reaction analyzing unit 104 may determine the magnitude of the reaction of the user to a sensory stimulus element, based on the change of the posture of the user measured by the posture measuring unit. There are some techniques known for how to measure a posture. Such techniques are described and disclosed in, for example, non-patent literatures “User Posture and Movement Estimation Based on 3-Axis Acceleration Sensor Position on the User's Body by KURASAWA Hisashi, KAWAHARA Yoshihiro, MORIKAWA Hiroyuki, and AOYAMA Tomonori, IPSJ SIG Note, IPSJ UBI Ubiquitous Computing Systems, pp. 15-22, 2006” and “Description of Human Motion Characteristics with 3-Dimensional Pose Measurement by SUMI Kazuhiko, TANAKA Koichi, and MATSUYAMA Takashi, Meeting on Image Recognition and Understanding 2004, vol. 1, pp. 660-665, 2004”. The posture measuring unit uses such techniques, accordingly, and measures the posture.

### <Analyzing User Reaction>

Detailed next is how to determine the magnitude of the reaction of the user to a sensory stimulus element. The magnitude of the reaction of the user to the sensory stimulus element is taken as the attention degree of the user to the sensory stimulus element.

The user reaction analyzing unit 104 may determine the magnitude of the reaction of the user to the sensory stimulus element, based on an eye gaze retention time. The eye gaze retention time is measured by the eye gaze measuring unit 106 as the eye gaze movement of the user, and is given to the sensory stimulus element. In general, people gaze at an object of their interest. The retention time of the eye gaze indicates how much a person is interested in and pays attention to the object. Thus the user reaction analyzing unit 104 compares a gaze coordinate system calculated based on an output from the eye gaze measuring unit 106 with the position where the visual stimulus element is presented, and measures an eye gaze retention time given to the sensory stimulus element. The user reaction analyzing unit 104 determines that the magnitude of the reaction of the user to the sensory stimulus element is greater as the eye gaze retention time is longer.

Moreover, the user reaction analyzing unit 104 may determine the magnitude of the reaction of the user to a sensory stimulus element, based on the number of saccades. The saccades are measured by the eye gaze measuring unit 106 as the eye gaze movement of the user, and observed between the main area of a video displayed by the display unit 101 and the sensory stimulus element. Suppose a person is doing an activity. When something stimulating interrupts the person and if the person gets interested in the stimulus, the person frequently pays attention to the interrupting stimulus. As a result, saccades occur. Thus when a user is viewing a video on a display device such as a TV, and if the video shows an interrupting stimulus which differs from the video and the user gets interested in the stimulus, saccades occur at the position where the stimulus is presented. Thus, based on a gaze coordinate system calculated out of an output from the eye gaze measuring unit 106, the user reaction analyzing unit 104 measures the number of the saccades observed between the main area of a video displayed by the display unit 101 and the position where the sensory stimulus element is presented. The magnitude of the reaction of the user to the sensory stimulus element is greater as more saccades are observed at the position where sensory stimulus element is presented.

The user reaction analyzing unit 104 may determine the magnitude of the reaction of the user to a sensory stimulus element, based on an eye blink frequency measured by the eye gaze measuring unit 106 as the eye gaze movement of the user. It is known that the occurrence of eye blinks is affected by attention and interest of a person. Thus the user reaction analyzing unit 104 may determine the attention degree to the sensory stimulus element based on an eye blink frequency measured by the eye gaze measuring unit 106. Specifically, the attention degree of the user to the sensory stimulus element is higher as the eye blink frequency is greater.

It is noted that, in the case where the user status measuring unit 103 includes a facial expression measuring unit 107, the user reaction analyzing unit 104 may determine the magnitude of the reaction of the user to the sensory stimulus element based on the change of the facial expression of the user. In the case where the user status measuring unit 103 includes a posture measuring unit 108 which measures the posture of the user, the user reaction analyzing unit 104 may determine a magnitude of a reaction to a sensory stimulus element, based on the change of the posture of the user.

### <Controlling Sensory Stimulus>

Detailed next is how to control a sensory stimulus.

First the sensory stimulus control unit 102 (i) presents a sensory stimulus element having a first stimulation degree, (ii) changes a stimulation degree of the sensory stimulus element from the first stimulation degree, based on the magnitude of the reaction determined by the user reaction analyzing unit 104, and presents the sensory stimulus element, and (iii) decreases the stimulation degree of the sensory stimulus element or stops presenting the sensory stimulus element in the case where the magnitude of the reaction is smaller than a predetermined threshold. Here the reaction is observed within a predetermined time period which begins when the sensory stimulus element having the first stimulation degree is presented. In the case where the magnitude of the reaction to the sensory stimulus is greater than or equal to a predetermined threshold, the sensory stimulus control unit 102 presents information to be shown to the user. Here the reaction is observed within a predetermined time period which begins when the sensory stimulus element having the first stimulation degree is presented.

In the case where the magnitude of the reaction of the user to the sensory stimulus element is greater than or equal to the first threshold, as shown in FIG. 2, the sensory stimulus control unit 102 may increase the intensity of the sensory stimulus element to check whether or not the user reaction is brief. In the case where the magnitude of the reaction of the user to the sensory stimulus element is smaller than the first threshold, the sensory stimulus control unit 102 may decrease the stimulation degree of the sensory stimulus element. This feature successfully prevents the sensory stimulus element from unnecessarily interrupting the user viewing the video. In contrast, when the attention degree of the user to the sensory stimulus element is higher than the first threshold, the sensory stimulus control unit 102 may increase the stimulation degree of the sensory stimulus element to find out the magnitude of the reaction of the user.

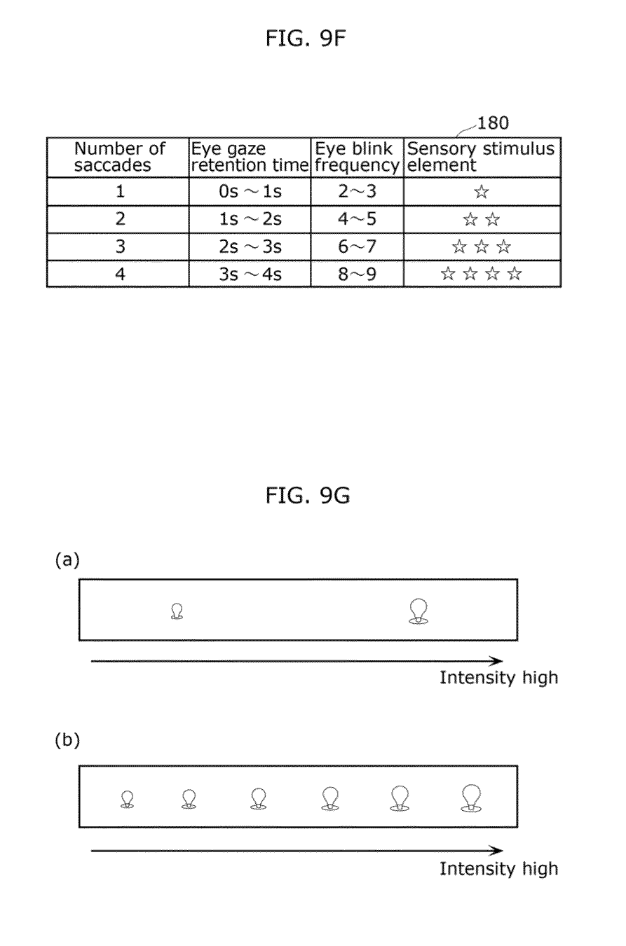

In Embodiment 1, the sensory stimulus control unit 102 presents a visual stimulus element as the sensory stimulus element, and calculates the stimulation degree of the sensory stimulus element based on a level of attractiveness to the visual stimulus element. In other words, the stimulation degree of the sensory stimulus element is determined based on the level of the attractiveness indicating to what degree the user is likely to gaze at the sensory stimulus element. FIG. 9A exemplifies the case where a pattern 150 is presented as visual stimulus elements. As shown in FIG. 9A, the stimulation degree of the sensory stimulus elements may be adjusted for the number of identical patterns 150 in Example 1, and for the color, brightness, and contrast for the pattern 150 in Example 2. In addition, the pattern 150 itself may be changed to show the change of the stimulation degree as shown in Example 3. The identical pattern 150 may be resized as shown in Example 4.

Furthermore, the sensory stimulus control unit 102 may present a sensory stimulus element on the screen of the display unit 101. Moreover, the sensory stimulus control unit 102 may present the sensory stimulus element by superimposing the sensory stimulus element on the video displayed by the display unit 101. FIG. 9B exemplifies the case where the pattern 150 is presented on the screen of the display unit 101, overlapping on the video displayed by the display unit 101. In addition, the sensory stimulus control unit 102 may present a sensory stimulus element which corresponds to brightness or a color contrast of the video displayed by the display unit 101. For example, in the case where the brightness of the video displayed on the display unit 101 is low, the sensory stimulus control unit 102 may present a sensory stimulus element having low brightness. In the case where the contrast of the video is high, the sensory stimulus control unit 102 may present a sensory stimulus element having high contrast. Hence the sensory stimulus control unit 102 may achieve a balance between the video and the stimulation degree of the sensory stimulus element. In addition, the stimulation degree of a sensory stimulus element may be determined according to a position where the pattern 150 is displayed as shown in Example 5 of FIG. 9B.

Furthermore, the sensory stimulus control unit 102 may cause a presenting device, provided to the bezel 111 of the display unit 101, to present a sensory stimulus element. FIG. 9C exemplifies the case where the presenting device is provided on the bezel 111 of the display unit 101. In Embodiment 1, the bezel 111 has level indicators 160 including a light-emitting diode (LED). The stimulation degree of the sensory stimulus element is adjusted based on how many of the level indicators 160 are on.

Furthermore, the sensory stimulus control unit 102 may present a sensory stimulus element outside the display unit 101. For example, as shown in FIG. 9D, a sensory stimulating device 170 may be provided apart from the display unit 101.

Moreover, the sensory stimulus control unit 102 may reduce the video displayed by the display unit 101, and present a sensory stimulus element in a manner that the video and the sensory stimulus element do not overlap with each other. For example, the video may be reduced as shown in FIG. 9E so that the pattern 150 may be presented on an area where the video is not displayed.

In addition, the sensory stimulus control unit 102 may present a sensory stimulus element having stimulation degree which is set based on the importance of information to be shown to the user. Here the stimulation degree of the sensory stimulus element may be Increased as the importance is higher. For example, the stimulation degree of the sensory stimulus element may be set high when the sensory stimulus control unit 102 receives, from the electric appliance 105 connected to the presentation control device 100, information of high importance such as the failure and malfunction of the electric appliance 105.

It is noted that the sensory stimulus control unit 102 may further include a sensory stimulus element database 180 which stores a sensory stimulus element having multiple stimulation degrees, and may present the sensory stimulus element with reference to data stored in the sensory stimulus element database 180. FIG. 9F exemplifies the sensory stimulus element database 180. The example in FIG. 9F shows that, in the sensory stimulus element database 180, each of sensory stimulus elements shown in the form of the pattern 150 is associated with the number of saccades, an eye gaze retention time, and an eye blink frequency. The sensory stimulus control unit 102 may present a sensory stimulus element with reference to the sensory stimulus element corresponding to the number of saccades, the eye gaze retention time, and the eye blink frequency.

FIG. 9G exemplifies a variation on the sensory stimulus elements according to Embodiment 1 of the present invention. As shown in FIG. 9G, the variation on the sensory stimulus element may consist of two steps as shown in the illustration (a), of six steps as shown in the illustration (b) or, as a matter of course, more than six steps.

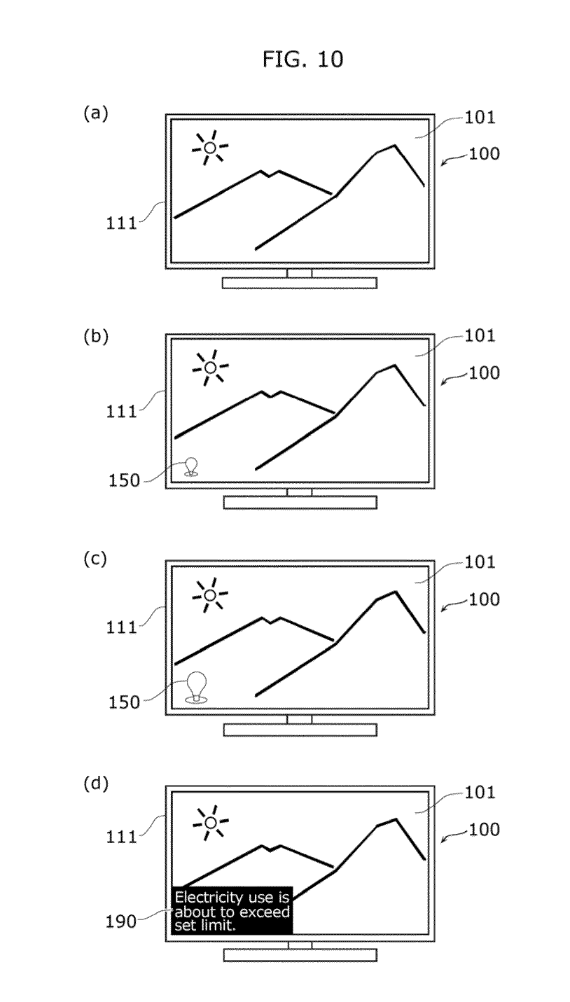

FIGS. 10 to 12 exemplify how to present information according to Embodiment 1 of the present invention. In all FIGS. 10 to 12, the pattern 150 is used as a sensory stimulus element, and displayed within the screen of the display unit 101.

The illustrations (a) in FIGS. 10 to 12 show that the sensory stimulus element is not presented. The illustrations (b) in FIGS. 10 to 12 show that the pattern 150, representing the sensory stimulus element having the first stimulation degree, is presented. The illustrations (c) in FIGS. 10 to 12 show that the stimulation degree of the sensory stimulus element is intensified. The illustrations (d) in FIGS. 10 to 12 show that notification information 190 is displayed.

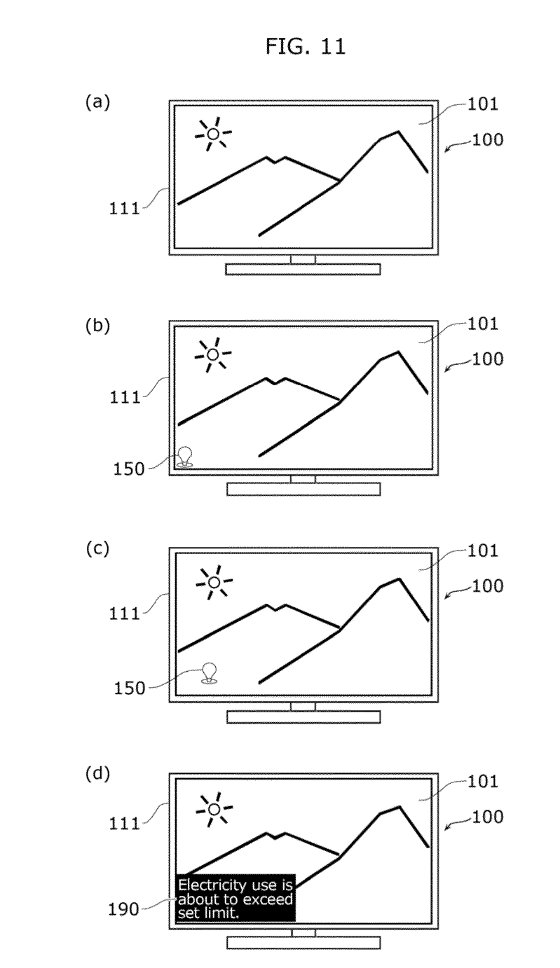

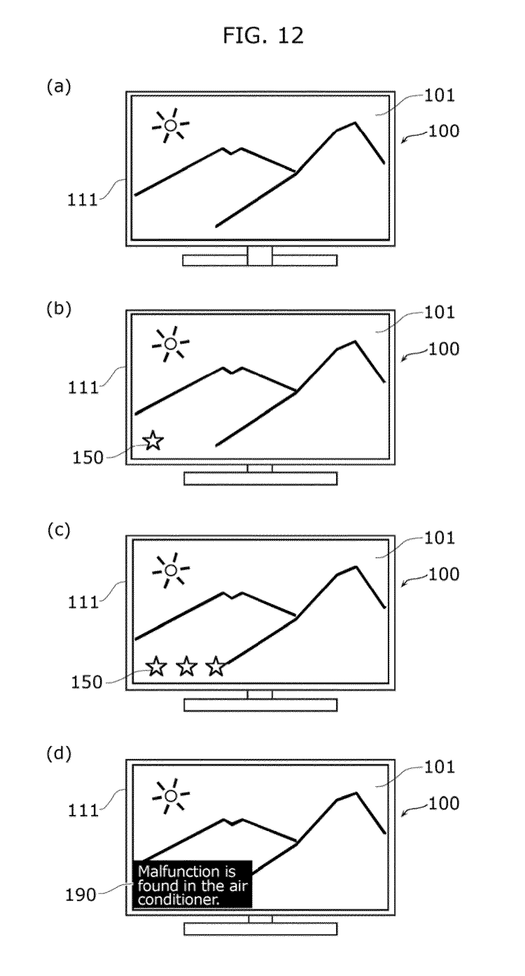

The stimulation degree of the sensory stimulus element is intensified between the illustrations (b) and (c) in FIGS. 10 to 12. In other words, the pattern 150 is larger and brighter between the illustrations (b) and (c) in FIG. 10, so that the stimulation degree of the sensory stimulus element is intensified. The position of the pattern 150 is moved from the edge toward the center of the screen of the display unit 101 between the illustrations (b) and (c) in FIG. 11, so that the stimulation degree of the sensory stimulus element is intensified. The number of the patterns 150 increases between the illustrations (b) and (c) in FIG. 12, so that the stimulation degree of the sensory stimulus element is intensified.

Thanks to the above features, the sensory stimulus control unit 102 (i) presents a sensory stimulus element having a first stimulation degree, (ii) changes a stimulation degree of the sensory stimulus element from the first stimulation degree, based on a magnitude of a reaction calculated by the user reaction analyzing unit 104, and presents the sensory stimulus element, and in the case where the magnitude of the reaction is smaller than a predetermined threshold, and (iii) decreases the stimulation degree of the sensory stimulus element or stops presenting the sensory stimulus element in the case where the magnitude of the reaction to the sensory stimulus element is smaller than a predetermined threshold. Here the reaction is observed within a predetermined time period which begins when the sensory stimulus element having the first stimulation degree is presented. Consequently, the sensory stimulus control unit 102 can casually present the user the information based on how the user is viewing the content item.

It is noted that the sensory stimulus control unit 102 may present an auditory stimulus element as the sensory stimulus element, and calculate the stimulation degree of the sensory stimulus element based on at least one of the volume of the auditory stimulus element and the musical pitch of the auditory stimulus element. The sensory stimulus control unit 102 may present an auditory stimulus element having audio properties which correspond to the audio of the video displayed by the display unit 101. For example, the sensory stimulus control unit 102 may present, as the auditory stimulus element, a sound which spontaneously suits the audio of the video that the user is viewing, and change the stimulation degree by changing the volume and the musical pitch. Here the stimulation degree is greater as the volume is higher. In addition, the stimulation degree is greater as the difference between the audio of the video and the musical pitch of the sensory stimulus element is larger.

Moreover, the sensory stimulus control unit 102 may present a tactile stimulus element as the sensory stimulus element, and calculate the stimulation degree of the sensory stimulus element based on at least one of the feeling of pressure of the tactile stimulus element and the feeling of touch of the tactile stimulus element. For example, the sensory stimulus control unit 102 may work with the user's sofa and chair, and provides, as the tactile stimulus element, vibration from the sofa and the chair to the user. Here the stimulation degree is greater as the vibration is stronger.

Furthermore, the sensory stimulus element may be an olfactory stimulus element. The stimulation degree of the olfactory stimulus element is greater as the odor is stronger, the odor is worse, or the odor is stronger and worse. For example, the sensory stimulus control unit 102 may work with an odor generating device, and provide, as the olfactory stimulus element, odor from the odor generating device. Here the stimulation degree is greater as the odor is stronger.

### Embodiment 2

The present invention is applicable to a display device which simultaneously displays multiple videos. Embodiment 2 describes a presentation control device used for simultaneously displaying multiple videos on a single screen of a display device.

It is noted that the block diagram showing the functional structure of the presentation control device according to Embodiment 2 is similar to that the block diagram in FIG. 1. Moreover, the operations of the user status measuring unit 103 and the user reaction analyzing unit 104 in Embodiment 2 are similar to those in Embodiment 1. Therefore the details thereof shall be omitted.

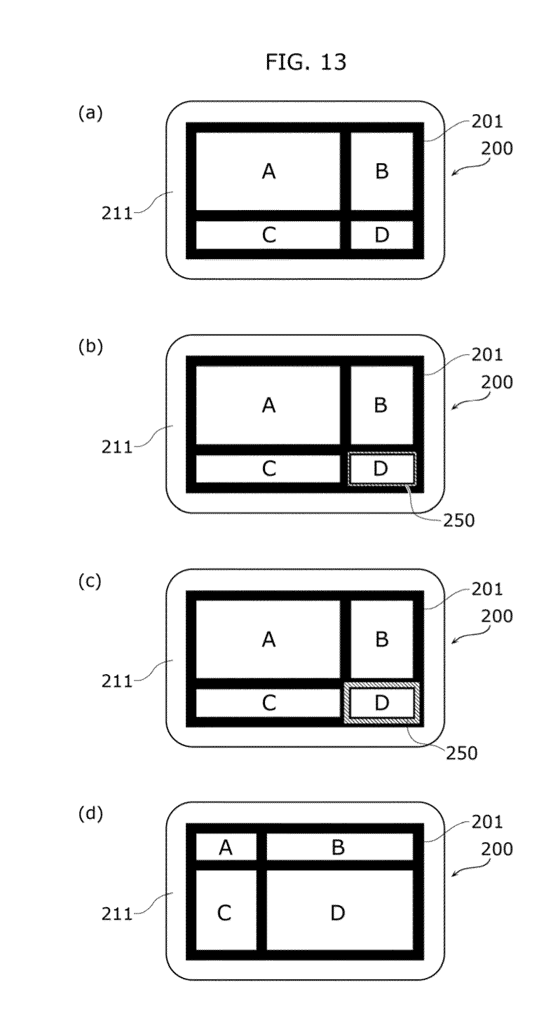

FIG. 13 shows the presentation control device according to Embodiment 2 of the present invention.

A presentation control device 200 is a large tablet terminal including a display unit 201 having a 20-inch display screen. In other words, the presentation control device 200 is applicable to a user interface for displaying content. The display screen of the display unit 201 has the horizontal resolution of approximately 4000 pixels, which is referred to as 4 k resolution. It is noted that a bezel 211 of the presentation control device 200 has the image capturing device 110 which works as the user reaction analyzing unit 104. As a matter of course, the image capturing device 110 may be provided out of the presentation control device 200.

As the illustration (a) in FIG. 13 shows, the display unit 201 can simultaneously display multiple videos on the display screen. The videos may be content items such as an electronic magazine and an electronic study material which include videos and text. Specifically, Embodiment 2 exemplifies the case where the display unit 201 simultaneously displays four videos on the display device. However, the number of simultaneously displayed videos shall not be defined as it is.

The presentation control device 200 can simultaneously display various content items on the display screen of the display unit 201. For example, the presentation control device 200 can simultaneously display videos A, B, C, and D as four of content items including TV broadcasting services such as a news program, an advertisement, a video on demand (VoD), the social networking system (SNS), an electronic magazine, and an electronic study material.

Among the four videos displayed by the display unit 201, the video A (first video) is the main content item that a user is mainly viewing. The illustration (a) in FIG. 13 shows that, on the display screen, the video A is larger than the videos B, C, and D. Among the four videos, the video D (second video) is a sub-content item which the user is not mainly viewing, as well as a sensory stimulus element presented by the sensory stimulus control unit 102. Moreover, the video D is information to be shown to the user. On the display screen, the video D is larger than the video A.

The example in FIG. 13 shows that the above-described sensory stimulus control unit 102 presents the video D to the user as the sensory stimulus element as described above. The user reaction analyzing unit 104 determines the magnitude of the reaction of the user to the video D, based on a user status measured by the user status measuring unit 103.

The sensory stimulus control unit 102 changes a stimulation degree of the video D from a first stimulation degree, based on a magnitude of a reaction determined by the user reaction analyzing unit 104, and presents (displays) the video D. Specifically, the sensory stimulus control unit 102 changes an appearance of the video D to change the stimulation degree of the video D.

Here the appearance change is to change how the video D looks, without changing the feature of the content item displayed as the video D. When the video D is a VoD content item, for example, the appearance change is to overlap another video on the VoD content item and change the color tone and the contrast of the VoD content item, with the VoD content itself kept displayed as it is. The appearance change also includes application of a specific effect to the video, such as a blinking video D.

FIG. 13 shows that a frame is added to the video D, and the stimulation degree of the video D is changed. Specifically, a frame 250 is overlapped on the video D as shown in the illustration (b) changed from the illustration (a) in FIG. 13. Hence the stimulation degree of the video D is increased. Moreover, as shown in the illustration (c) in FIG. 13, the frame 250 having a thicker frame is overlapped on the video D. Hence the sensory stimulus control unit 102 can increase the stimulation degree of the video D greater than the stimulation degree shown in the illustration (b) in FIG. 13. It is noted that how to change the stimulation degree in adding a frame to the video D as shown in FIG. 13 shall not be limited to changing the thickness of the frame. For example, the frame may be blinked, and the stimulation degree is changed based on a time interval between the blinks. The color for the frame may be changed to change the stimulation degree.

Moreover, in the case where the magnitude of the reaction of the user to the video D is greater than or equal to a predetermined threshold, the sensory stimulus control unit 102 presents the user information to be shown—the video D—as the main content item. Here the reaction is observed within a predetermined time period which begins when the video D having the first stimulation degree is presented.

Specifically, as shown in the illustration (d) in FIG. 13, the sensory stimulus control unit 102 causes the display unit 201 to display the video D so that, on the display screen, the video D is larger than the video A.

It is noted that, for example, in the case where the magnitude of the reaction of the user to the video D is greater than or equal to the predetermined threshold, the sensory stimulus control unit 102 may display the video D at the location of and in the size of the video A shown in the illustration (a) in FIG. 13. Here the reaction is observed within a predetermined time period which begins when the video D having the first stimulation degree is presented. In other words, the positions of the video A and the video D may be switched to each other.

Hence, through the screen transition which changes, based on how the user is viewing the videos, the sizes and the layout of the multiple videos on the screen, the sensory stimulus control unit 102 can casually present the videos (provide information).

It is noted that the sensory stimulus control unit 102 may change the stimulation degree of the video D by changing the displayed feature of the video D to.

Here the change of the displayed feature is to change the feature of the content item displayed as the video D. For example, in the case where the video D is a still image (photo), the change of the displayed feature is to display another still image than the still image currently displayed as the video D. In addition, in the case where the video D includes an SNS text message, for example, the change of the displayed feature is to move the text message and resize the text letters. Moreover, in the case where the video D is a TV program, for example, the change of the displayed feature is typically to change the channel of the TV program shown as the video D.

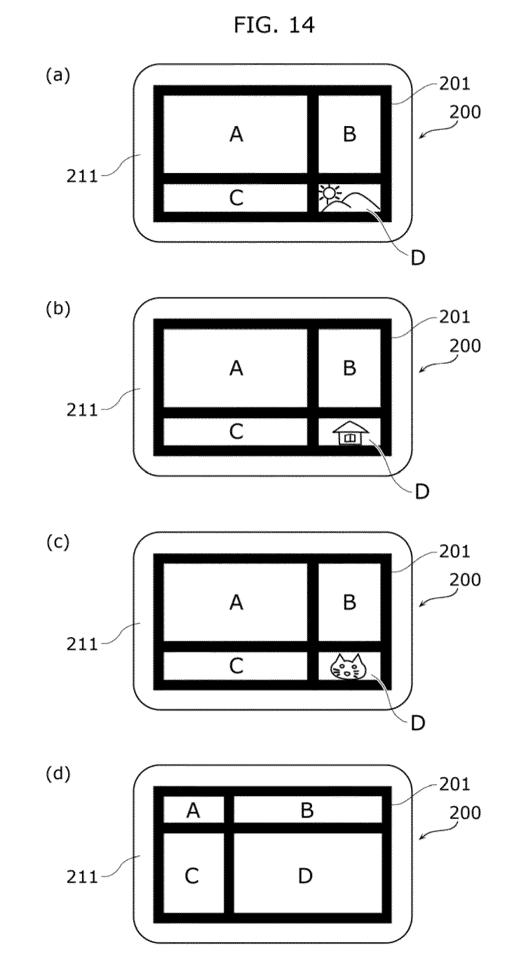

FIG. 14 exemplifies how to change a stimulation degree by changing the displayed feature of the video D. As an example, a still image is displayed as the video D.

The illustration (a) in FIG. 14 shows a still image of scenery as the video D. From this point, the sensory stimulus control unit 102 displays, as the video D, a still image of a building to change the stimulation degree of the video D. Moreover, the sensory stimulus control unit 102 displays, as the video D, a still image of an animal as shown in the illustration (c) changed from the Illustration (b) in the FIG. 14. Hence the sensory stimulus control unit 102 further changes the stimulation degree of the video D. Eventually, as shown in the illustration (d) in FIG. 14, the video D is presented to the user as the main content item (information to be shown to the user), in the case where the magnitude of the reaction of the user to the video D is greater than a predetermined threshold when the reaction is observed within a predetermined time period which begins when the video D having a first stimulation degree is presented.

As described above, the video D works as a sensory stimulus element when the video D changes from a still image to another still image.

It is noted that the stimulation degree here is determined based on, for example, how often still images are replaced (time interval for the replacement of still images). Frequent replacement of the images shows a high stimulation degree. Less frequent replacement of the images shows a low stimulation degree.

Furthermore, the stimulation degree may be associated with a still image itself. For example, the sensory stimulus control unit 102 previously obtains, for each of still images, the average luminance of each of the pixels forming the still images. A still image having a higher average luminance of the pixels (a brighter still image) is easier for the user to recognize and higher in stimulation degree. In other words, the sensory stimulus control unit 102 may change the stimulation degree by selecting and presenting a still image having a stimulation degree to be presented based on the average luminance. The sensory stimulus control unit 102 previously obtains, for each of still images, the number of pixels whose change in luminance, with respect to the surrounding pixels, is greater than a predetermined value. Suppose the case where a still image has a large number of pixels whose change in luminance with respect to their neighboring pixels is greater than a predetermined value. Such a still image is easier for the user to recognize and higher in stimulation degree. In other words, the sensory stimulus control unit 102 may select and present a still image having a stimulation degree to be presented based on the number of pixels, and may change the stimulation degree. Furthermore, the sensory stimulus control unit 102 may associate the attractiveness of the visual attention for a still image; namely saliency, with a stimulation degree. Greater saliency shows a higher stimulation degree, and smaller saliency shows a lower stimulation degree. A non-patent literature “Itti, L. and Koch, C.: Computational modeling of visual attention. Nature Reviews Neuroscience, 2(3), pp. 194-203” is known for introducing a technique to calculate the saliency.

Described above is Embodiment 2 of the present invention with reference to FIGS. 13 and 14.

According to FIGS. 13 and 14, in the case where the magnitude of the reaction of the user to the video D is greater than or equal to a predetermined value within a predetermined time period which begins when the video D having the first stimulation degree is presented, the sensory stimulus control unit 102 may enlarge the size of the video D on the display screen, increase the amount of information that the video D contains, and display the video D.

Specifically, the amount of information is the number of letters to be displayed on the display screen when, for example, an SNS content item is displayed as the video D. Furthermore, increasing the amount of information for the video D and displaying the video D correspond to the case where the video D, that is enlarged and displayed as the main content item, is displayed as a regular (not thumbnail) still image when multiple still images are reduced and displayed as thumbnails.

Such features make it possible to enlarge the video D and display the video D as the main content item and to obtain more detailed information through the display screen when the user pays attention to the video D; namely, the sensory stimulus element. In other words, the information is casually presented to the user.

It is noted that, in Embodiment 2, the presentation control device of the present invention is applied to a tablet terminal. As a matter of course, the presentation control device in Embodiment 2 may also be applicable to a smartphone.

Although only exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

Furthermore, the present invention may be modified as described below.

(1) Specifically, the presentation control device is a computer system including a micro processor, a Read Only Memory (ROM), a Random Access Memory (RAM), a hard-disk unit, a display unit, a keyboard, a mouse, and the like. The ROM or the hard-disk unit stores a computer program. The presentation control device achieves its functions through the microprocessor's operation according to the computer program. Here the computer program includes a combination of multiple instruction codes sending an instruction to the computer in order to achieve a predetermined function. It is noted that the presentation control device shall not be limited to a computer system including all of a microprocessor, a ROM, a RAM, a hard-disk unit, a display unit, a keyboard, and a mouse, but may be a computer system including some of them.

(2) Some or all of the structural elements included in the presentation control device may be included in a single system Large Scale Integration (LSI). A system LSI is an ultra-multifunction LSI manufactured with plural structural units integrated on a single chip. Specifically, the system LSI is a computer system having a micro processor, a ROM, a RAM, and the like. The ROM stores a computer program. The system LSI achieves its functions through the microprocessor's operation according to the computer program.

The system LSI introduced here may be referred to as an Integrated circuit (IC), an LSI, a super LSI, an ultra LSI, depending on integration density. Moreover, a technique of integrating into a circuit shall not be limited to the form of an LSI; instead, integration may be achieved in the form of a designated circuit or a general purpose processor. Employed as well may be the following: a Field Programmable Gate Array (FPGA) which is programmable after manufacturing of the LSI; or a reconfigurable processor which makes possible reconfiguring connections and configurations of circuit cells within the LSI.

Furthermore, if an integrated circuit technology that replaces the LSI appears thorough the progress in the semiconductor technology or another derived technology, that technology can naturally be used to carry out integration of the constituent elements. Biotechnology can be applied to the integrated circuit technology.

(3) Some or all of the constituent elements constituting the presentation control device may be configured as an IC card which can be attached and detached from each apparatus or as a stand-alone module. The IC card or the module is a computer system which consists of a micro processor, a ROM, a RAM, and the like. The IC card and the module may also include the ultra-multifunction LSI. The IC card or the module achieves its function through the microprocessor's operation according to the computer program. The IC card or the module may also be implemented to be tamper-resistant.

(4) The present invention may be implemented in the form of a method including operations of characteristic structural units, which the presentation control device has, as steps. The method may be achieved in a form of a computer program executed on a computer or digital signals including the computer program.

Furthermore, the present invention may also be implemented by storing the computer program or the digital signal in a non-transitory computer-readable recording medium such as a flexible disc, a hard disk, a CD-ROM, an MO, a DVD, a DVD-ROM, a DVD-RAM, a BD (Blu-ray Disc®), and semiconductor memory. The present invention may also be the computer program or the digital signals recorded in the recording media.

The present invention may further transmit the computer program or the digital signals via a network and data broadcast mainly including an electronic communications line, a wireless or a wired communications line and the Internet.

The present invention can be implemented by another independent computer system by storing and transferring the program or the digital signals in a recording medium or via a network.

### INDUSTRIAL APPLICABILITY

The presentation control device according to an implementation of the present invention is useful as a video displaying device such as a TV capable of casually presenting information to a user.

### REFERENCE SIGNS LIST

100 and 200 Presentation control device
101 and 201 Display unit
102 Sensory stimulus control unit
103 User status measuring unit
104 User response analyzing unit
105 Electric appliance
106 Eye gaze measuring unit
110 Image capturing device
111 and 211 Bezel
112 Face part region database (DB)
113 Face part region template database (DB)
114 Area including the corner and the tail of the eye
115 Region with little luminance
120 First region
130 Second region
140 Black-part-of-eye detecting filter
150 Pattern
160 Level indicator
170 Sensory stimulating device
180 Sensory stimulus element database
190 Notification information
250 Frame

1. A presentation control device comprising:
a display unit configured to display a video;
a sensory stimulus control unit configured to present a sensory stimulus element for notifying a user of information to be shown to the user through the display unit;
a user status measuring unit configured to measure a status of the user; and
a user reaction analyzing unit configured to determine a magnitude of a reaction of the user to the sensory stimulus element, based on an output from the user status measuring unit,
wherein the sensory stimulus control unit is configured to:
present the sensory stimulus element having a first stimulation degree;
change a stimulation degree of the sensory stimulus element from the first stimulation degree, based on the magnitude of the reaction determined by the user reaction analyzing unit, and present the sensory stimulus element; and
decrease the stimulation degree of the sensory stimulus element or stop presenting the sensory stimulus element in the case where the magnitude of the reaction of the user to the sensory stimulus element is smaller than a predetermined threshold, the reaction being observed within a predetermined time period which begins when the sensory stimulus element having the first stimulation degree is presented.

2. The presentation control device according to Claim 1,
wherein the sensory stimulus control unit is configured to present the information to be shown to the user in the case where the magnitude of the reaction of the user to the sensory stimulus element is greater than or equal to a predetermined threshold, the reaction being observed within a predetermined time period which begins when the sensory stimulus element having the first stimulation degree is presented.

3. The presentation control device according to Claim 1,
wherein the sensory stimulus control unit is configured to:
present a visual stimulus element as the sensory stimulus element; and
calculate the stimulation degree of the sensory stimulus element based on a level of attractiveness to the visual stimulus element.

4. The presentation control device according to Claim 1,
wherein the sensory stimulus control unit is configured to:
present an auditory stimulus element as the sensory stimulus element; and
calculate the stimulation degree of the sensory stimulus element based on at least one of volume of the auditory stimulus element and a musical pitch of the auditory stimulus element.

5. The presentation control device according to Claim 1,
wherein the sensory stimulus control unit is configured to:
present a tactile stimulus element as the sensory stimulus element; and
calculate the stimulation degree of the sensory stimulus element based on at least one of feeling of pressure of the tactile stimulus element and feeling of touch of the tactile stimulus element.

6. The presentation control device according to Claim 1,
wherein the sensory stimulus control unit is configured to:
present an olfactory stimulus element as the sensory stimulus element; and
calculate the stimulation degree of the sensory stimulus element based on at least one of how strong or weak odor of the olfactory stimulus element is and how good or bad the odor of the olfactory stimulus element is.

7. The presentation control device according to Claim 1,
wherein the sensory stimulus control unit further includes a sensory stimulus element database which stores the sensory stimulus element having multiple stimulation degrees including the stimulation degree, and is configured to present the sensory stimulus element with reference to data stored in the sensory stimulus element data base.

8. The presentation control device according to Claim 1,
wherein the sensory stimulus control unit is configured to present the sensory stimulus element on a screen of the display unit.

9. The presentation control device according to Claim 1,
wherein the sensory stimulus control unit is configured to cause a presenting device, provided to a bezel of the display unit, to present the sensory stimulus element.

10. The presentation control device according to Claim 1,
wherein the sensory stimulus control unit is configured to present the sensory stimulus element outside the display unit.

11. The presentation control device according to Claim 3,
wherein the sensory stimulus control unit is configured to present the sensory stimulus element by superimposing the sensory stimulus element on the video displayed by the display unit.

12. The presentation control device according to Claim 11,
wherein the sensory stimulus control unit is configured to present the sensory stimulus element which corresponds to brightness or a color contrast of the video displayed by the display unit.

13. The presentation control device according to Claim 3,
wherein the sensory stimulus control unit is configured to: reduce the video displayed by the display unit; and
present the sensory stimulus element in a manner that the video and the sensory stimulus element do not overlap with each other.

14. The presentation control device according to Claim 4,
wherein the sensory stimulus control unit is configured to present the auditory stimulus element having audio properties which correspond to audio of the video displayed by the display unit.

15. The presentation control device according to Claim 1,
wherein the sensory stimulus control unit is configured to present the sensory stimulus element having the stimulation degree which is set based on importance of the information to be shown to the user.

16. The presentation control device according to Claim 1,
wherein the user status measuring unit further includes an eye gaze measuring unit configured to measure an eye gaze movement of the user as the status of the user.

17. The presentation control device according to Claim 16,
wherein the user reaction analyzing unit is configured to determine the magnitude of the reaction of the user to the sensory stimulus element, based on an eye gaze retention time which is (i) measured by the eye gaze measuring unit as the eye gaze movement of the user and (ii) given to the sensory stimulus element.

18. The presentation control device according to Claim 16,
wherein the user reaction analyzing unit is configured to determine the magnitude of the reaction of the user to the sensory stimulus element, based on the number of saccades which are (i) measured by the eye gaze measuring unit as the eye gaze movement of the user and (ii) observed between the sensory stimulus element and a main area of the video displayed by the display unit.

19. The presentation control device according to Claim 16,
wherein the user reaction analyzing unit is configured to determine the magnitude of the reaction of the user to the sensory stimulus element, based on eye blink frequency which is measured by the eye gaze measuring unit as the eye gaze movement of the user.

20. The presentation control device according to Claim 1,
wherein the user status measuring unit further includes a facial expression measuring unit configured to measure a facial expression of the user as the status of the user, and
the user reaction analyzing unit is configured to determine the magnitude of the reaction of the user to the sensory stimulus element, based on a change of the facial expression of the user measured by the facial expression measuring unit.

21. The presentation control device according to Claim 1,
wherein the user status measuring unit further includes a posture measuring unit configured to measure a posture of the user as the status of the user, and
the user reaction analyzing unit is configured to determine the magnitude of the reaction of the user to the sensory stimulus element, based on a change of the posture of the user measured by the posture measuring unit.

22. The presentation control device according to Claim 2,
wherein the display unit is configured to simultaneously display a first video and a second video which is smaller than the first video in size on a screen of the display unit,
the second video is the information to be shown to the user as well as is the sensory stimulus element to be presented by the sensory stimulus control unit,
the user reaction analyzing unit is configured to determine a magnitude of a reaction of the user to the second video, based on an output from the user status measuring unit, and
the sensory stimulus control unit is configured to:
present the second video having a first stimulation degree;
change a stimulation degree of the second video from the first stimulation degree, based on the magnitude of the reaction determined by the user reaction analyzing unit, and present the second video;
decrease the stimulation degree of the second video in the case where a magnitude of a reaction of the user to the second video is smaller than a predetermined threshold, the reaction being observed within a predetermined time period which begins when the second video having the first stimulation degree is presented; and
present the second video on the display unit in the case where the magnitude of the reaction of the user to the second video is greater than or equal to the predetermined threshold, the second video being larger than the first video in size on the screen of the display unit.

23. The presentation control device according to Claim 22,
wherein the sensory stimulus control unit is configured to change the stimulation degree of the second video by changing an appearance of the second video.

24. The presentation control device according to Claim 22,
wherein the sensory stimulus control unit is configured to change the stimulation degree of the second video by changing a feature of the second video.

25. The presentation control device according to Claim 24,
wherein the sensory stimulus control unit is configured to:
present a still picture as the second video; and
change the stimulation degree of the second video by changing the presented still picture to another still picture which differs from the presented still picture.

26. An integrated circuit which performs presentation control, the integrate circuit comprising:
a sensory stimulus control unit configured to present a sensory stimulus element for notifying a user of information to be shown to the user;
a user status measuring unit configured to measure a status of the user; and
a user reaction analyzing unit configured to determine a magnitude of a reaction of the user to the sensory stimulus element, based on an output from the user status measuring unit,
wherein the sensory stimulus control unit is configured to:
present the sensory stimulus element having a first stimulation degree;
change a stimulation degree of the sensory stimulus element from the first stimulation degree, based on the magnitude of the reaction determined by the user reaction analyzing unit, and present the sensory stimulus element; and
decrease the stimulation degree of the sensory stimulus element or stop presenting the sensory stimulus element in the case where the magnitude of the reaction of the user to the sensory stimulus element is smaller than a predetermined threshold, the reaction being observed within a predetermined time period which begins when the sensory stimulus element having the first stimulation degree is presented.

27. A presentation control method comprising:
presenting a sensory stimulus element for notifying a user of information to be shown to the user through a display unit;
measuring a status of the user; and
determining a magnitude of a reaction of the user to the sensory stimulus element, based on an output in the measuring,
wherein the presenting involves:
presenting the sensory stimulus element having a first stimulation degree;
changing a stimulation degree of the sensory stimulus element from the first stimulation degree, based on the magnitude of the reaction determined in the determining, and presenting the sensory stimulus element; and
decreasing the stimulation degree of the sensory stimulus element or stop presenting the sensory stimulus element in the case where the magnitude of the reaction of the user to the sensory stimulus element is smaller than a predetermined threshold, the reaction being observed within a predetermined time period which begins when the sensory stimulus element having the first stimulation degree is presented.

28. A program for causing a computer to execute the presentation control method according to Claim 27.

29. A non-transitory computer-readable recording medium which stores the program according to Claim 28.
